(19) United States
(12) Patent Application Publication
(10) Pub. No.: US 2026/0274370 A1
(43) Pub. Date: Sep. 17, 2026

(54) EASILY SWITCHABLE MULTI-CONFIGURATION CHILDREN'S TRICYCLE

(71) Applicant: FUJIAN BESREY BABY PRODUCTS CO., LTD., FUQING (CN)

(72) Inventors: Long Zhao, FUQING (CN); Qiushui Huang, FUQING (CN); Pengcheng Gan, FUQING (CN); Zhongjun Zhu, FUQING (CN)

(21) Appl. No.: 19/533,486

(22) Filed: Feb. 9, 2026

(30) Foreign Application Priority Data
Mar. 17, 2025 (CN) 202520461641.0

(51) Int. Cl. B62K 9/02; B62K 19/30

(52) U.S. Cl. CPC B62K 9/02; B62K 19/30

(57) ABSTRACT

An easily switchable multi-configuration children's tricycle, including a frame, a first rear wheel assembly, and a second rear wheel assembly. The first rear wheel assembly includes a first rear wheel frame and two first rear wheels, the two first rear wheels are respectively rotatably disposed at two ends of the first rear wheel frame, and a middle portion of the first rear wheel frame is detachably connected to a rear end of the frame. The second rear wheel assembly includes a second rear wheel frame and a second rear wheel, the second rear wheel is rotatably disposed at the second rear wheel frame, and the second rear wheel frame is detachably disposed at the rear end of the frame or the first rear wheel frame. By enabling quick-release replacement, a gliding function is provided for children, facilitates storage and transport, allows for simple mode switching.

### TECHNICAL FIELD

The present disclosure relates to a technical field of children's strollers, and in particular to an easily switchable multi-configuration children's tricycle.

### BACKGROUND

Children's tricycles are popular toys among children and also serve as ride-on toys for short-distance mobility. Riding a tricycle allows children to exercise muscles around knee joints, improve their motor skills, and promote physical development, all of which contribute to healthy growth.

In conventional children's tricycles, switching a rear wheel assembly between balance bike mode and tricycle mode requires rotation of rear foot joints, which changes a distance between two rear wheels. At the same time, the two rear wheels must rotate together to maintain parallel alignment, leading to complicated operation. In addition, a plurality of rotating locations and excessive clearances result in significant wobble of the entire vehicle.

### SUMMARY

In view of the above, the present disclosure aims to provide an easily switchable multi-configuration children's tricycle based on deficiencies in the prior art, in which a rear wheel assembly enhances a gliding function of the easily switchable multi-configuration children's tricycle while being easy to store and transport. Additionally, a switching mode between multiple configurations is simple, and the easily switchable multi-configuration children's tricycle operates without need for joint rotation, resulting in minimal wobbling and strong stability.

To achieve above aims, the present disclosure adopts technical solutions as follows.

The present disclosure provides the easily switchable multi-configuration children's tricycle, including a frame, a first rear wheel assembly, and a second rear wheel assembly. The first rear wheel assembly includes a first rear wheel frame and two first rear wheels, the two first rear wheels are respectively rotatably disposed at two ends of the first rear wheel frame, and a middle portion of the first rear wheel frame is detachably connected to a rear end of the frame. The second rear wheel assembly includes a second rear wheel frame and a second rear wheel, the second rear wheel is rotatably disposed at the second rear wheel frame, and the second rear wheel frame is detachably disposed at the rear end of the frame or the first rear wheel frame.

Furthermore, a rear fork shaft is disposed at the rear end of the frame, the rear fork shaft includes two first interfitting tubes, and the two first interfitting tubes are symmetrically arranged and extend rearward along a vehicle body. Two second interfitting tubes are disposed on the first rear wheel frame corresponding to the two first interfitting tubes. Two third interfitting tubes are disposed on the second rear wheel frame corresponding to the two first interfitting tubes. An interfitting post is disposed on the first rear wheel assembly corresponding to the two third interfitting tubes.

Furthermore, first limiting through holes are respectively defined on tube walls of the two first interfitting tubes, and elastic plungers are respectively disposed in the two first interfitting tubes. Each of the elastic plungers includes a first limiting post and a first elastic member, each first limiting post and a corresponding first elastic member are integrally formed, each first limiting post is inserted in a corresponding one of the first limiting through holes, and each first elastic member imparts a radially outward bias to a corresponding first limiting post relative to a corresponding one of the two first interfitting tubes. An inner diameter of each of the two second interfitting tubes and an inner diameter of each of the two third interfitting tubes are not less than an outer diameter of each of the two first interfitting tubes. Second limiting through holes corresponding to the first limiting through holes are respectively defined on tube walls of the two second interfitting tubes and tube walls of the two third interfitting tubes.

Furthermore, an outer diameter of the interfitting post is not greater than the inner diameter of each of the two third interfitting tubes, a second elastic member is disposed on a side wall of the interfitting post, and a second limiting post is disposed on an outer side of the second elastic member corresponding to a corresponding one of the second limiting through holes.

Furthermore, unlocking buttons are respectively disposed on the two second interfitting tubes and the two third interfitting tubes. Each of the unlocking buttons includes a free end and an unlocking end. Each free end is connected to a corresponding one of the two second interfitting tubes and the two third interfitting tubes through fasteners, a push column is disposed at each unlocking end, each push column is disposed at an outer side of a corresponding one of the first limiting through holes, and a diameter of each push column is less than a diameter of the corresponding one of the first limiting through holes.

Furthermore, two fourth interfitting tubes are disposed on one side of the first rear wheel frame opposite to the two second interfitting tubes and are parallel to the two second interfitting tubes. An outer diameter of each of the two fourth interfitting tubes is not greater than an inner diameter of a corresponding one of the two third interfitting tubes.

Furthermore, third elastic members are respectively disposed in the two second interfitting tubes and the two third interfitting tubes. Stop blocks are respectively disposed at end portions of the two first interfitting tubes. The third elastic members cooperate with the stop blocks to bias the two first interfitting tubes to move away from the two second interfitting tubes or the two third interfitting tubes.

Furthermore, the third elastic members are springs, and clamping grooves are respectively defined in the two second interfitting tubes and the two third interfitting tubes, and an inner diameter of each of the clamping grooves is equal to an outer diameter of a corresponding one of the springs.

Furthermore, guiding grooves are respectively defined at openings of the two second interfitting tubes and openings of the two third interfitting tubes, and a depth of each of the guiding grooves is gradually decreased from an inlet end thereof toward a fixed end thereof.

The present disclosure has significant advantages and beneficial effects compared to the prior art. Specifically, based on the above technical solutions, a key feature lies in the first rear wheel assembly and the second rear wheel assembly being detachably disposed at the rear end of the frame. This allows users to quickly switch a configuration of the easily switchable multi-configuration children's tricycle according to their needs, adapting the easily switchable multi-configuration children's tricycle to different usage scenarios, thereby enhancing the tricycle's adaptability and flexibility. By providing multiple configuration options, the users may flexibly adjust setup of the easily switchable multi-configuration children's tricycle based on the child's needs or changing usage environments, improving overall user experience. Due to such detachable design of the first rear wheel assembly and the second rear wheel assembly, when one of the first rear wheel assembly and the second rear wheel assembly is damaged or needs replacing, the users may replace only that particular wheel assembly, rather than an entire device of the easily switchable multi-configuration children's tricycle, reducing maintenance costs. Additionally, when one of the first rear wheel assembly and the second rear wheel assembly is not in use, it may be removed to reduce a size of the easily switchable multi-configuration children's tricycle, enabling easier storage and transportation of the easily switchable multi-configuration children's tricycle. Such switching mode between multiple configurations is simple, and the entire vehicle of the easily switchable multi-configuration children's tricycle operates without the need for joint rotation, resulting in minimal wobbling and strong stability.

To more clearly illustrate structural features and effects of the present disclosure, following provides a detailed description of the present disclosure in conjunction with accompanying drawings and specific embodiments.

### BRIEF DESCRIPTION OF DRAWINGS

FIG. 1 is a schematic diagram of an assembled structure of an easily switchable multi-configuration children's tricycle according to a first embodiment of the present disclosure.

FIG. 2 is an exploded structural schematic diagram of the easily switchable multi-configuration children's tricycle according to one embodiment of the present disclosure.

FIG. 3 is a structural schematic diagram of a first rear wheel assembly according to one embodiment of the present disclosure.

FIG. 4 is a structural schematic diagram of a second rear wheel assembly according to one embodiment of the present disclosure.

FIG. 5 is an exploded cross-sectional schematic diagram of the first rear wheel assembly and a rear fork shaft according to one embodiment of the present disclosure.

FIG. 6 is a structural schematic diagram of an unlocking button according to one embodiment of the present disclosure.

FIG. 7 is a schematic diagram of the assembled structure of the easily switchable multi-configuration children's tricycle according to a second embodiment of the present disclosure.

FIG. 8 is a schematic diagram of the assembled structure of the easily switchable multi-configuration children's tricycle according to a third embodiment of the present disclosure.

Reference numerals in the drawings: 100. frame; 10. rear fork shaft; 111. first interfitting tube; 112. first limiting through hole; 120. elastic plunger; 121. first limiting post; 122. first elastic member; 200. first rear wheel assembly; 210. first rear wheel frame; 211. second interfitting tube; 212. fourth interfitting tube; 220. first rear wheel; 230. interfitting post; 231. second elastic member; 232. second limiting post; 300. second rear wheel assembly; 310. second rear wheel frame; 311. third interfitting tube; 320. second rear wheel; 400. second limiting through hole; 410. third elastic member; 411. clamping groove; 420. stop block; 430. guiding groove; 500. unlocking button; 510. free end; 520. unlocking end; 521. push column.

### DETAILED DESCRIPTION OF EMBODIMENTS

In make objectives, technical solutions, and advantages of the present disclosure clearer, following detailed description of the present disclosure is provided in conjunction with accompanying drawings and embodiments. It should be understood that specific embodiments described herein are merely used for explaining the present disclosure and are not intended to limit a scope of the present disclosure.

It should be noted that when an element is referred to as being “fixed to” another element, it may be directly on the other element or intervening elements may also be present. When an element is considered to be “connected” to another element, it may be directly connected to the other element or intervening elements may be present at the same time. Terms “vertical”, “horizontal”, “left”, “right”, and similar expressions used herein are for illustrative purposes only.

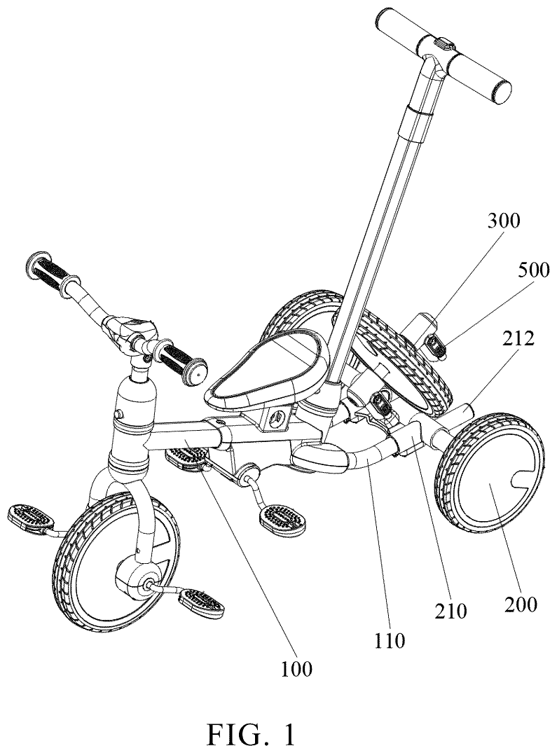

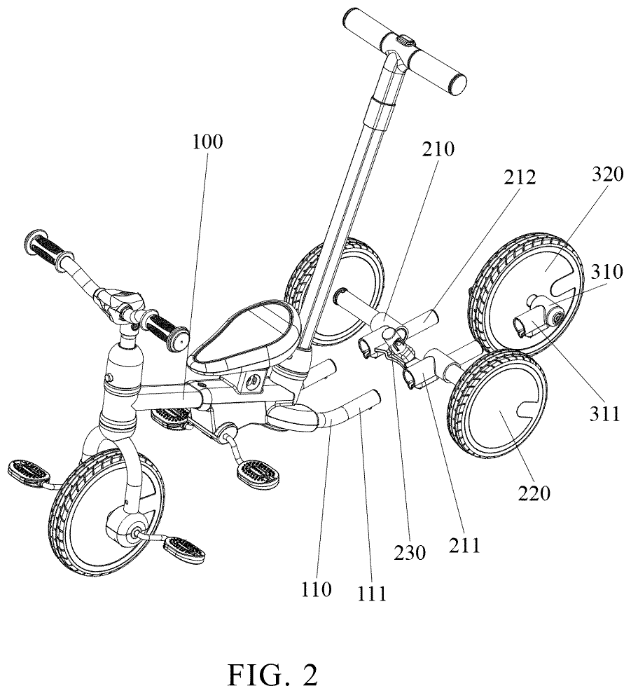

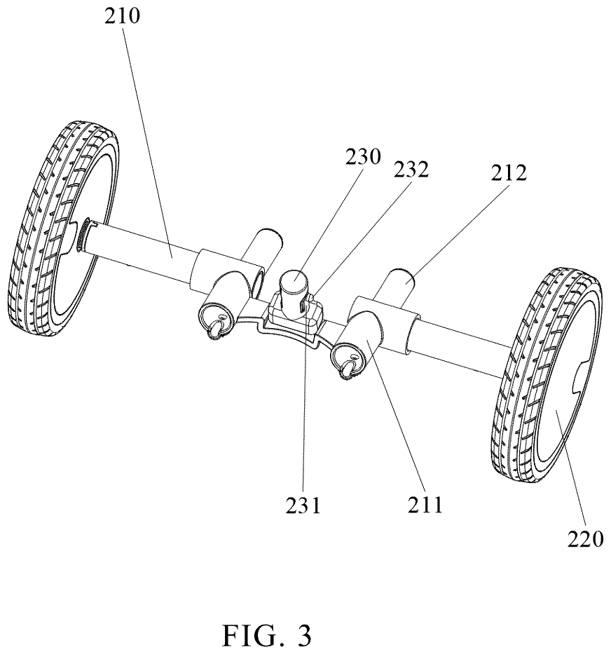

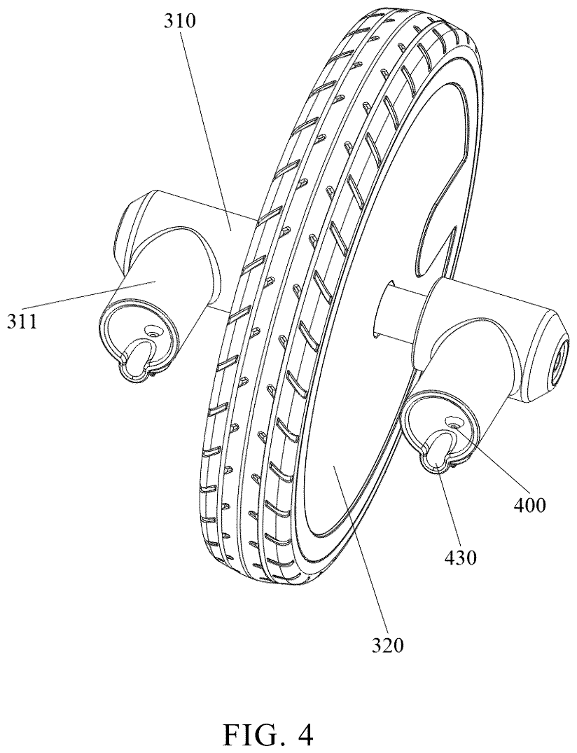

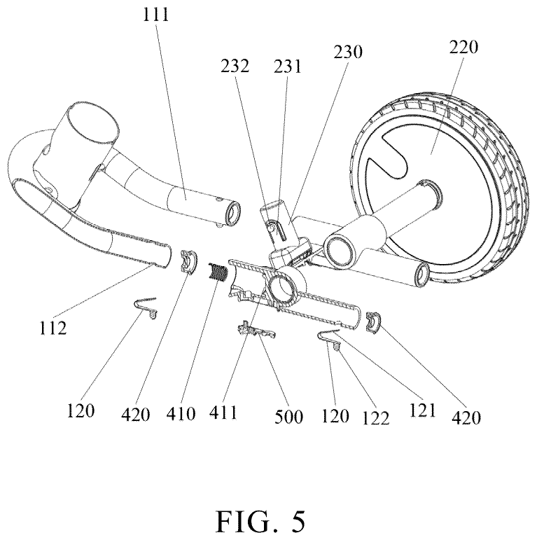

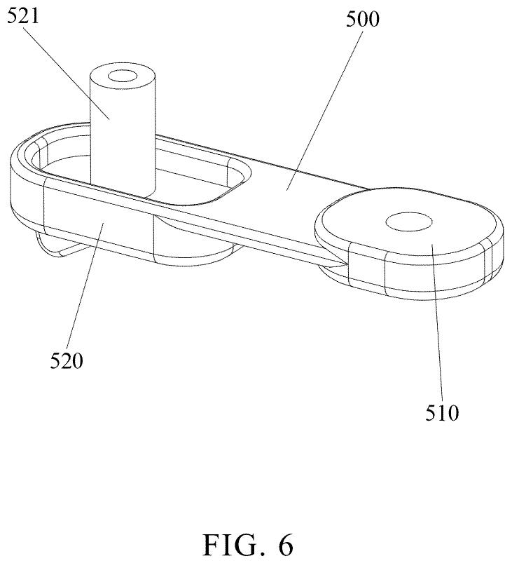

Please refer to FIGS. 1-8, the embodiments of the present disclosure provides an easily switchable multi-configuration children's tricycle, including a frame 100, a first rear wheel assembly 200, and a second rear wheel assembly 300. The first rear wheel assembly 200 includes a first rear wheel frame 210 and two first rear wheels 220, the two first rear wheels 220 are respectively rotatably disposed at two ends of the first rear wheel frame 210, and a middle portion of the first rear wheel frame 210 is detachably connected to a rear end of the frame 100. The second rear wheel assembly 300 includes a second rear wheel frame 310 and a second rear wheel 320, the second rear wheel 320 is rotatably disposed at the second rear wheel frame 310, and the second rear wheel frame 310 is detachably disposed at the rear end of the frame 100 or the first rear wheel frame 210.

Furthermore, a rear fork shaft 10 is disposed at the rear end of the frame 100, the rear fork shaft 10 includes two first interfitting tubes 111, and the two first interfitting tubes 111 are symmetrically arranged along a central axis of the easily switchable multi-configuration children's tricycle and extend rearward along a vehicle body. Two second interfitting tubes 211 are disposed on the first rear wheel frame 210 corresponding to the two first interfitting tubes 111. Two third interfitting tubes 311 are disposed on the second rear wheel frame 310 corresponding to the two first interfitting tubes 111. An interfitting post 230 is disposed between the two second interfitting tubes 211. The second rear wheel 320 is disposed between the two third interfitting tubes 311. The interfitting post 230 is disposed on the first rear wheel assembly 200 corresponding to the two third interfitting tubes 311, and the interfitting post 230 is configured to store and mount the second rear wheel assembly 300 on the first rear wheel assembly 200 when the second rear wheel assembly 300 is not in use. A diameter of the second rear wheel 320 is greater than a diameter of each of the two first rear wheels 220.

Furthermore, first limiting through holes 112 are respectively defined on tube walls of the two first interfitting tubes 111, and the first limiting through holes 112 penetrate through the tube walls of the two first interfitting tubes 111. Elastic plungers 120 are respectively disposed in the two first interfitting tubes 111. Each of the elastic plungers 120 includes a first limiting post 121 and a first elastic member 122, each first limiting post 121 and a corresponding first elastic member 122 are integrally formed, each first limiting post 121 is inserted in a corresponding one of the first limiting through holes 112, and each first elastic member 122 imparts a radially outward bias to a corresponding first limiting post 121 relative to a corresponding one of the two first interfitting tubes 111. An inner diameter of each of the two second interfitting tubes 211 and an inner diameter of each of the two third interfitting tubes 311 are not less than an outer diameter of each of the two first interfitting tubes. Second limiting through holes 400 corresponding to the first limiting through holes 112 are respectively defined on tube walls of the two second interfitting tubes 211 and tube walls of the two third interfitting tubes 311, and the second limiting through holes 400 penetrate through the tube walls of the two second interfitting tubes 211 and the tube walls of the two third interfitting tubes 311. During interfitting assembly, the elastic plungers 120 are respectively engaged with the second limiting through holes 400, thereby fixing the first rear wheel assembly 200 or the second rear wheel assembly 300 onto the rear fork shaft 110, enabling quick installation.

Furthermore, an outer diameter of the interfitting post 230 is not greater than the inner diameter of each of the two third interfitting tubes 311, a second elastic member 231 is disposed on a side wall of the interfitting post 230, and a second limiting post 323 is disposed on an outer side of the second elastic member 231 corresponding to a corresponding one of the second limiting through holes 400. By providing the second elastic member 231 on the side wall of the interfitting post 230 and engaging the second limiting post 232 with the corresponding one of the second limiting through holes 400, the two third interfitting tubes 311 are securely held and is not easily detached after being sleeved over the interfitting post 230, thereby fixing the second rear wheel assembly 300 onto the first rear wheel assembly 200. This allows the second rear wheel assembly 300 to be easily replaced while being carried, making it convenient to swap an assembly of the easily switchable multi-configuration children's tricycle at any time.

Furthermore, unlocking buttons 500 are respectively disposed on the two second interfitting tubes 211 and the two third interfitting tubes 311. Each of the unlocking buttons 500 includes a free end 510 and an unlocking end 520. Each free end 510 is connected to a corresponding one of the two second interfitting tubes 211 and the two third interfitting tubes 311 through fasteners, a push column 521 is disposed at each unlocking end 520, each push column 521 is disposed at an outer side of a corresponding one of the first limiting through holes 112, and a diameter of each push column 521 is less than a diameter of the corresponding one of the first limiting through holes 112. By pressing each unlocking end 520, a corresponding push column 521 extends into a corresponding one of the second limiting through holes 400 and pushes a corresponding first limiting post 121 out of the corresponding one of the second limiting through holes 400, thereby unlocking the first rear wheel assembly 200 or the second rear wheel assembly 300 from the rear fork shaft 110. Provision of each unlocking button 500 facilitates pushing a corresponding first limiting post 121 out of a corresponding one of the second limiting through holes 400, so that detaching the first rear wheel assembly 200 and the second rear wheel assembly 300 is convenient.

Furthermore, two fourth interfitting tubes 212 are disposed on one side the first rear wheel frame 210 opposite to the two second interfitting tubes 211 and are parallel to the two second interfitting tubes 211. An outer diameter of each of the two fourth interfitting tubes 212 is not greater than an inner diameter of a corresponding one of the two third interfitting tubes 311, such that the second rear wheel assembly 300 may be directly assembled behind the first rear wheel assembly 200 without removing the first rear wheel assembly 200, thereby switch a configuration of the easily switchable multi-configuration children's tricycle into a balance-bike configuration. Likewise, additional first limiting through holes 112 are defined on tube walls of the two fourth interfitting tube 212s, and additional elastic plungers 120 are respectively disposed within in the two fourth interfitting tubes 212.

Furthermore, third elastic members 410 are respectively disposed in the two second interfitting tubes 211 and the two third interfitting tubes 311. Stop blocks 420 are respectively disposed at end portions of the two first interfitting tubes 111 corresponding to the third elastic members 410. The third elastic members 410 cooperate with the stop blocks 420 to bias the two first interfitting tubes 111 to move away from the two second interfitting tubes 211 or the two third interfitting tubes 311. Likewise, additional stop blocks 420 are disposed at end portions of the two fourth interfitting tubes 212. When each unlocking button 500 on a corresponding side is pressed to push the corresponding first limiting post 121 out of the corresponding one of the second limiting through holes 400, a corresponding one of the two second interfitting tubes 211 or a corresponding one of the two third interfitting tubes 311 are urged by an elastic force of a corresponding one of the third elastic members 410, in cooperation with a corresponding one of the stop blocks 420, to spring away from and separate from a corresponding one of the two first interfitting tubes 111, thereby enabling rapid disassembly.

Furthermore, the two third elastic members 410 are springs, and clamping grooves 411 are respectively defined in the two second interfitting tubes 211 and the two third interfitting tubes 311, and an inner diameter of each of the clamping grooves 411 is equal to an outer diameter of a corresponding one of the springs. Each of the springs is secured within a corresponding one of the two second interfitting tubes 211 and the two third interfitting tubes 311 by an interference fit between each of the springs and a corresponding one of the clamping grooves 411.

Furthermore, guiding grooves 430 are respectively defined at openings of the two second interfitting tubes 211 and openings of the two third interfitting tubes 311, and a depth of each of the guiding grooves 430 is gradually decreased from an inlet end thereof toward a fixed end thereof. The guiding grooves 430 are configured to guide an insertion angle and direction of the two second interfitting tubes 211 and the two third interfitting tubes 311, such that each first limiting post 121 and the second limiting post 232 may smoothly snap into corresponding second limiting through holes 400.

Assembly and disassembly process of the rear wheel assembly 200 of the present disclosure are as follows.

During assembly, the two second interfitting tubes 211 or the two third interfitting tubes 311 are respectively sleeved onto the two first interfitting tubes 111. Each first limiting post 121 is retracted under guidance of a corresponding one of the guiding grooves 430. When the two second interfitting tubes 211 or the two third interfitting tubes 311 move to positions where the first limiting through holes 112 align with the second limiting through holes 400, each first limiting post 121 moves radially outward and snap into a corresponding one of the second limiting through holes 400, thereby completing locking.

During disassembly, each unlocking buttons 500 on the corresponding side is pressed to push the corresponding first limiting post 121 out of the corresponding one of the second limiting through holes 400 to achieve unlocking. Through cooperation between the third elastic members 410 and the stop blocks 420, the corresponding one of the two second interfitting tubes 211 or the corresponding one of the two third interfitting tubes 311 are urged by the elastic force of the corresponding one of the third elastic members 410, in cooperation with the corresponding one of the stop blocks 420, to spring away from and separate from the corresponding one of the two first interfitting tubes 111, thereby enabling rapid disassembly.

Three embodiments with different assembly and usage modes of the present disclosure are as follows.

According to a first embodiment of the present, as shown in FIG. 1, the two second interfitting tubes 211 of the first rear wheel assembly 200 are connected to the rear fork shaft 110, and the two third interfitting tubes 311 of the second rear wheel assembly 300 are sleeved onto the interfitting post 230 of the first rear wheel assembly 200, thereby completing the assembly of the easily switchable multi-configuration children's tricycle. In this state, the second rear wheel assembly 300 is carried on the first rear wheel assembly 200, which allows the second rear wheel assembly 300 to be easily replaced while being carried, making it convenient to swap the assembly of the easily switchable multi-configuration children's tricycle at any time.

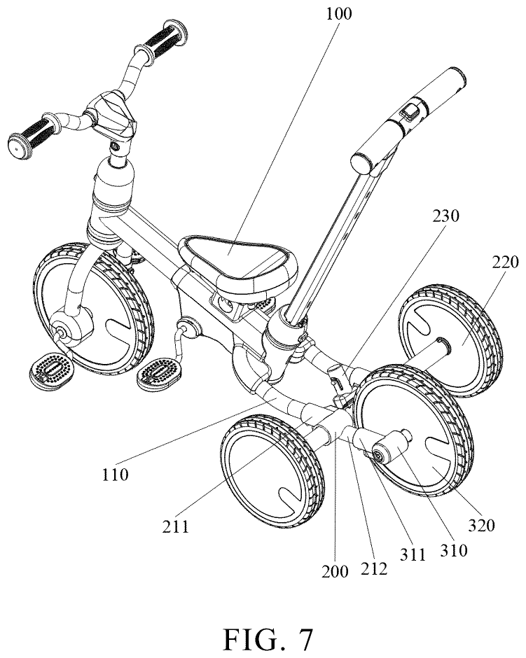

According to a second embodiment of the present, as shown in FIG. 7, the second rear wheel assembly 300 from the first embodiment is removed from the interfitting post 230, and the two third interfitting tubes 311 of the second rear wheel frame 310 are inserted into the two fourth interfitting tubes 212 of the first rear wheel assembly 200, thereby switching the configuration of the easily switchable multi-configuration children's tricycle into the balance-bike configuration. In this state, the two first rear wheels 220 serve as auxiliary anti-fall wheels, further improving stability and anti-fall performance.

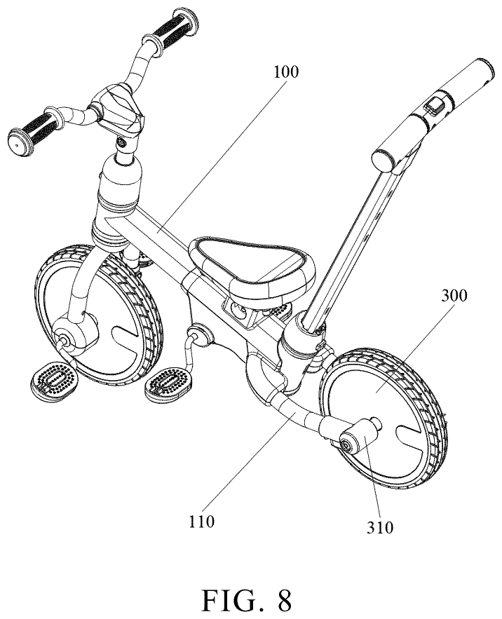

According to a third embodiment of the present disclosure, as shown in FIG. 8, the first rear wheel assembly 200 is removed from the rear fork shaft 110, and then the two third interfitting tubes 311 of the second rear wheel assembly 300 are sleeved onto the rear fork shaft 110, thereby switching the easily switchable multi-configuration children's tricycle into a two-wheeled balance-bike configuration.

Based on the above, in the easily switchable multi-configuration children's tricycle of the present disclosure, interfitting tubes are respectively disposed on both the first rear wheel assembly 200 and the second rear wheel assembly 300 to correspondingly connect to the rear fork shaft 110, thereby enabling the first rear wheel assembly 200 or the second rear wheel assembly 300 to be quickly assembled to or disassembled from the rear end of the frame 100. Quick assembly is achieved via such interfitting snap-fit mechanism, and quick disassemble is realized through cooperation of each unlocking button 5, corresponding third elastic members 410, and corresponding stop blocks 420. By switching between configurations, the tricycle provides a gliding function for children's use, facilitates storage and transport, and allows for simple mode switching. Moreover, an entire vehicle of the easily switchable multi-configuration children's tricycle operates without need for joint rotation, resulting in minimal wobbling and strong stability, and the easily switchable multi-configuration children's tricycle further offers multiple assembly configurations to accommodate riding needs of children of different ages.

The above are only preferred embodiments of the present disclosure and are not intended to limit the present disclosure. Any modification, equivalent replacement and improvement made within a principle of the present disclosure shall fall within a protection scope of the present disclosure.

What is claimed is:

1. An easily switchable multi-configuration children's tricycle, comprising:
a frame;
a first rear wheel assembly; and
a second rear wheel assembly;
wherein the first rear wheel assembly comprises a first rear wheel frame and two first rear wheels, the two first rear wheels are respectively rotatably disposed at two ends of the first rear wheel frame, and a middle portion of the first rear wheel frame is detachably connected to a rear end of the frame;
wherein the second rear wheel assembly comprises a second rear wheel frame and a second rear wheel, the second rear wheel is rotatably disposed at the second rear wheel frame, and the second rear wheel frame is detachably disposed at the rear end of the frame or the first rear wheel frame.

2. The easily switchable multi-configuration children's tricycle according to claim 1, wherein a rear fork shaft is disposed at the rear end of the frame, the rear fork shaft comprises two first interfitting tubes, and the two first interfitting tubes are symmetrically arranged and extend rearward along a vehicle body;
two second interfitting tubes are disposed on the first rear wheel frame corresponding to the two first interfitting tubes;
two third interfitting tubes are disposed on the second rear wheel frame corresponding to the two first interfitting tubes; and
an interfitting post is disposed on the first rear wheel assembly corresponding to the two third interfitting tubes.

3. The easily switchable multi-configuration children's tricycle according to claim 2, wherein first limiting through holes are respectively defined on tube walls of the two first interfitting tubes, and elastic plungers are respectively disposed in the two first interfitting tubes;
each of the elastic plungers comprises a first limiting post and a first elastic member, each first limiting post and a corresponding first elastic member are integrally formed, each first limiting post is inserted in a corresponding one of the first limiting through holes, and each first elastic member imparts a radially outward bias to a corresponding first limiting post relative to a corresponding one of the two first interfitting tubes;
an inner diameter of each of the two second interfitting tubes and an inner diameter of each of the two third interfitting tubes are not less than an outer diameter of each of the two first interfitting tubes; and
second limiting through holes corresponding to the first limiting through holes are respectively defined on tube walls of the two second interfitting tubes and tube walls of the two third interfitting tubes.

4. The easily switchable multi-configuration children's tricycle according to claim 3, wherein an outer diameter of the interfitting post is not greater than the inner diameter of each of the two third interfitting tubes, a second elastic member is disposed on a side wall of the interfitting post, and a second limiting post is disposed on an outer side of the second elastic member corresponding to a corresponding one of the second limiting through holes.

5. The easily switchable multi-configuration children's tricycle according to claim 3, wherein unlocking buttons are respectively disposed on the two second interfitting tubes and the two third interfitting tubes; and
each of the unlocking buttons comprises a free end and an unlocking end; each free end is connected to a corresponding one of the two second interfitting tubes and the two third interfitting tubes through fasteners, a push column is disposed at each unlocking end, each push column is disposed at an outer side of a corresponding one of the first limiting through holes, and a diameter of each push column is less than a diameter of the corresponding one of the first limiting through holes.

6. The easily switchable multi-configuration children's tricycle according to claim 3, wherein two fourth interfitting tubes are disposed on one side of the first rear wheel frame opposite to the two second interfitting tubes and are parallel to the two second interfitting tubes; and
an outer diameter of each of the two fourth interfitting tubes is not greater than an inner diameter of a corresponding one of the two third interfitting tubes.

7. The easily switchable multi-configuration children's tricycle according to claim 3, wherein third elastic members are respectively disposed in the two second interfitting tubes and the two third interfitting tubes;
stop blocks are respectively disposed at end portions of the two first interfitting tubes; and
the third elastic members cooperate with the stop blocks to bias the two first interfitting tubes to move away from the two second interfitting tubes or the two third interfitting tubes.

8. The easily switchable multi-configuration children's tricycle according to claim 7, wherein the third elastic members are springs, and clamping grooves are respectively defined in the two second interfitting tubes and the two third interfitting tubes, and an inner diameter of each of the clamping grooves is equal to an outer diameter of a corresponding one of the springs.

9. The easily switchable multi-configuration children's tricycle according to claim 3, wherein guiding grooves are respectively defined at openings of the two second interfitting tubes and openings of the two third interfitting tubes, and a depth of each of the guiding grooves is gradually decreased from an inlet end thereof toward a fixed end thereof.
